(19) United States
(12) Patent Application Publication
(10) Pub. No.: US 2020/0348562 A1
(43) Pub. Date: Nov. 5, 2020

(54) COLOR FILTER SUBSTRATE AND MANUFACTURING METHOD THEREOF, AND DISPLAY PANEL

(71) Applicant: Shenzhen China Star Optoelectronics Semiconductor Display Technology Co., Ltd., Shenzhen, Guangdong (CN)

(72) Inventor: Wen SHI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/081,382

(22) PCT Filed: Jan. 25, 2018
(86) PCT No.: PCT/CN2018/074102

§ 371 Date: Aug. 30, 2018

(30) Foreign Application Priority Data
Aug. 24, 2017 (CN) 201710738497.0

(51) Int. Cl. G02F 1/1335; G02F 1/13357

(52) U.S. Cl. CPC G02F 1/133516; G02F 2001/133614; G02F 1/1336; G02F 1/133512

(57) ABSTRACT

A color filter substrate and a manufacturing method thereof are provided. A surface modification agent is used to modify an outside surface of a quantum dot material to lower surface energy of the quantum dot material. The quantum dot material is then mixed with a color resist material to form a color filter mixture solution, and the color filter mixture solution is then dried. Since the quantum dot material has lowered surface energy, during the process of drying the color filter mixture material, the quantum dot material and the color resist material are automatically separated into different layers thereby simultaneously forming a quantum dot layer and a color resist layer, so as to reduce the operations of manufacturing a color filter substrate and lower down the manufacturing cost.

### RELATED APPLICATIONS

This application claims the priority of Chinese Patent Application No. 201710738497.0 filed on Aug. 24, 2017, titled “COLOR FILTER SUBSTRATE AND MANUFACTURING METHOD THEREOF, AND DISPLAY PANEL”, the disclosure of which is incorporated herein by reference in its entirety.

### BACKGROUND OF THE INVENTION

### 1. Field of the Invention

The present invention relates to the field of display technology, and more particularly to a color filter substrate and a manufacturing method thereof, and a display panel and a display device.

### 2. The Related Arts

Liquid crystal displays that are commonly available in the market have a color gamut around 68-72% NTSC, which do not provide high quality displaying performance. A quantum dot (QD) display panel that is currently available may significantly improve the gamut of the display panel to achieve displaying performance of high quality. A quantum dot material is a photoluminescence material and is referred to inorganic semiconductor nanometer particles having a particle size between 1-100 nm. Due to the small particle size of the quantum dot, electron and hole within the quantum dot are limited in respect of movement thereof in all three dimensions such that a continuous energy band structure is changed into discrete energy level structure demonstrating molecular characteristics and would emit fluorescent light upon excitation. Due to the discrete energy level structure, the spectral full width half maximum (FWHM) is relatively narrow so that the purity of light color is relatively high and thus the gamut of the display panel can be greatly improved. Further, the wavelength of the emitting light can be easily adjusted through changing the size of the quantum dot, allowing for further enhancement of displaying result of the display panel.

In the state of the art, a blue or violet backlight source is used to excite a quantum dot layer of a color filter substrate to achieve three-color displaying involving red, green, and blue. However, a portion of short wave light emitting from the backlight source cannot be completely absorbed and converted by the quantum dots so that light leaking may occur in the quantum dot layer and thus the purity of light exiting the color filter substrate would be affected. In the state of the art, to eliminate light leaking in the quantum dot layer, a color resist layer that matches the wave length of the light emitting from quantum dot layer must be first provided on the substrate and the a quantum dot layer is then formed on the color resist layer. The color resist layer absorbs the short wave light from the backlight source and then, the quantum dot layer emits light. However, the color resist layer and the quantum dot layer so formed must be fabricated separately and this increases the operations of manufacturing of the color filter substrate, leading to a high manufacturing cost.

### SUMMARY OF THE INVENTION

The present invention provides a color filter substrate, which allow a color resist layer and a quantum dot layer to be formed simultaneously in order to reduce the operations of manufacturing of the color filter substrate and thus reduce the manufacturing cost.

The color filter substrate comprises a base plate and a color resist layer and a quantum dot layer sequentially stacked on the base plate. The quantum dot layer has a light emission wavelength identical to a light transmission wavelength of the color resist layer. Quantum dots have outside surfaces that are combined with surface modification groups.

In the above, the color filter substrate further comprises a black matrix. The black matrix is stacked on the base plate. The black matrix comprises a plurality of deposition troughs arranged in an array. The deposition troughs have a bottom wall comprising the base plate. The quantum dot layer comprises a plurality of quantum dot layer areas arranged in an array. The color resist layer comprises a plurality of color resist layer areas arranged in an array. Each of the deposition troughs receives one of the quantum dot layer areas and one the color resist layer areas deposited therein such that the color resist layer area is located between the quantum dot layer area and the base plate.

In the above, the plurality of quantum dot layer areas comprise multiple red-light quantum dot areas and multiple green-light quantum dot areas, or alternatively comprise multiple red-light quantum dot areas, multiple green-light quantum dot areas, and multiple blue-light quantum dot areas; the plurality of color resist layer areas comprise multiple red color resist areas and multiple green color resist areas, or alternatively comprise multiple red color resist areas, multiple green color resist areas, and multiple blue color resist areas, wherein in each of the deposition troughs, the quantum layer area deposited therein has an emission light color that is identical to a color of the color resist layer area deposited therein.

In the above, the surface modification groups comprise fluorine-contained groups.

The present invention also provides a manufacturing method of a color filter substrate, which comprises the following steps:

providing a base plate and depositing a black matrix material layer on the base plate;

patterning the black matrix material layer to form a black matrix, wherein the black matrix comprises a plurality of deposition troughs arranged in an array;

synthesizing and forming quantum dots, such that the quantum dots having outside surfaces that are combined with surface modification groups;

providing a color resist material and a solvent and mixing the color resist material and the quantum dots so synthesized and formed with the solvent to form color filter mixture solutions;

depositing the color filter mixture solutions in the deposition troughs, respectively; and

drying the color filter mixture solutions to simultaneously form a color resist layer and a quantum dot layer stacked on the color resist layer, wherein the color resist layer is located between the base plate and the quantum dot layer.

In the above, the step of “drying the color filter mixture solutions” comprises:

allowing the color filter mixture solutions to dry naturally so as to have the quantum dots and the color resist material contained in the color filter mixture solution separate into different layers;

applying vacuum drying or heating drying to the color filter mixture solutions to remove the solvent from the color filter mixture solution so as to simultaneously formed the color resist layer and the quantum dot layers stacked on the color resist layer with the color resist layer being located between the base plate and the quantum dot layer.

In the above, the surface modification groups comprise fluorine-contained groups.

In the above, the solvent comprises one of water, alcohol, and glycerol.

The present invention further provides a display panel, which comprises a liquid crystal layer, an array substrate, and the above-described color filter substrate. The array substrate and the color filter substrate are arranged opposite to each other. The liquid crystal layer is located between the color filter substrate and the array substrate.

The present invention provides a color filter substrate and a manufacturing method thereof. A surface modification agent is used to modify an outside surface of a quantum dot material to lower surface energy of the quantum dot material. The quantum dot material is then mixed with a color resist material to form a color filter mixture solution, and the color filter mixture solution is then dried. Since the quantum dot material has lowered surface energy, during the process of drying the color filter mixture material, the quantum dot material and the color resist material are automatically separated into different layers thereby simultaneously forming a quantum dot layer and a color resist layer, so as to reduce the operations of manufacturing a color filter substrate and lower down the manufacturing cost.

### BRIEF DESCRIPTION OF THE DRAWINGS

To more clearly explain the technical solution proposed in an embodiment of the present invention or that of the prior art, a brief description of the drawings that are necessary for describing the embodiment or the prior art is given as follows. It is obvious that the drawings that will be described below show only some embodiments of this application. For those having ordinary skills of the art, other obvious variations may be readily available from these attached drawings without the expense of creative effort and endeavor.

FIG. 1 is a schematic view, in a sectioned form, illustrating a color filter substrate according to an embodiment of the present invention;

FIG. 2 is a flow chart illustrating a manufacturing method of the color filter substrate shown in FIG. 1; and

FIGS. 3-5 are schematic views, in sectioned form, illustrating each step of the manufacturing of the color filter substrate shown in FIG. 1.

### DETAILED DESCRIPTION OF THE PREFERRED EMBODIMENTS

A clear and complete description will be given to technical solutions provided in embodiments of the present invention, with reference being had to the attached drawings of the embodiments of the present invention. However, the embodiments so described are only some, but not all, of the embodiments of the present invention. Other embodiments that are available to those having ordinary skills of the art without the expense of creative effort and endeavor are considered belonging to the scope of protection of the present invention.

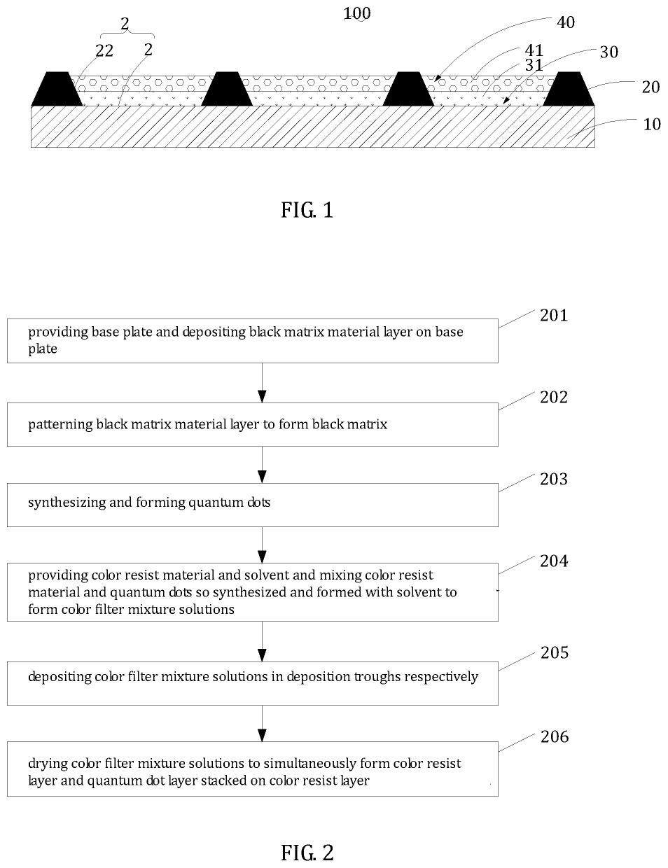

Referring to FIG. 1, the present invention provides a color filter substrate 100. The color filter substrate 100 comprises a base plate 10, a black matrix 20 stacked on the base plate 10, and a color resist layer 30 and a quantum dot layer 40 stacked, in sequence, on the base plate 10.

The base plate 10 is a transparent plate, which can be a glass plate that is rigid or a plastic plate that is flexible. In the instant embodiment, the base plate 10 is a transparent glass plate.

The black matrix 20 is stacked on the base plate 10. The black matrix 20 comprises a plurality of deposition troughs 21 arranged in an array. The deposition troughs 21 each comprise a sidewall 22 and a bottom wall 23. The bottom wall 23 comprises a surface of the base plate 10 that faces the black matrix 20.

The color resist layer 30 comprises a film of a color resist, which is stacked on the surface of the base plate 10. In the instant embodiment, the color resist layer 30 comprises a plurality of color resist layer areas 31 arranged in an array. Each of the deposition troughs 21 receives one of the color resist layer areas 31 deposited therein. In other words, the color resist layer areas 31 are arranged to correspond, in a one to one manner, to the deposition troughs 21 and are respectively received in the deposition troughs 21. Also, the color resist layer areas 31 are deposited on the bottom walls 23 of the deposition troughs. In the present invention, the plurality of color resist layer areas 31 comprise multiple red color resist areas, multiple green color resist areas, and multiple blue color resist areas. It is appreciated that in case that the backlight source is of a blue color, the blue backlighting may directly transmit through the base plate 10 to emit blue light so that the plurality of color resist layer areas 31 may only include multiple red color resist areas and multiple green color resist areas, but do not comprise blue color resist areas.

The quantum dot layer 40 is stacked on a surface of the color resist layer 30 that is distant from the base plate 10. The quantum dot layer 40 comprises a thin film formed of quantum dots. The quantum dot layer 40 comprises a plurality of quantum dot layer areas 41 arranged in an array. The quantum dot layer areas 41 are arranged to respectively correspond, in a one to one manner, to the deposition troughs 21 and received in the deposition troughs 21. In the instant embodiment, the plurality of quantum dot layer areas 41 comprise multiple red-light quantum dot areas, multiple green-light quantum dot areas, and multiple blue-light quantum dot areas. It is appreciated that in case that the backlight source is of a blue color, the blue backlighting may directly transmit through the base plate 10 to emit blue light so that the plurality of quantum dot layer areas 41 may only include multiple red-light quantum dot areas and multiple green-light quantum dot areas, but do not comprise blue-light quantum dot areas.

The quantum dot layer 40 have a light emission wavelength that is identical to a light transmission wavelength of the color resist layer 30 so as to ensure that the light emitting from the quantum dot layer 40 may transmit through the organic photo resist layer 30 and project from the base plate 10. Light of other short wave that is not absorbed and converted by the quantum dot 40 cannot transmit through the organic photo resist layer 30, so as to ensure high purity of the color of light penetrating through the color resist layer 30 and the base plate 10 to thus provide a better effect of displaying.

In the instant embodiment, the quantum dot layer areas 41 deposited in the deposition troughs 21 have light emission colors that are respectively identical to colors of the color resist layer areas 31 deposited therein. In other words, one of the red color resist areas and one of the red-light quantum dot areas are sequentially stacked and received in one of the deposition troughs 21; one of the green color resist areas and one of the green-light quantum dot areas are sequentially stacked and received in one of the deposition troughs 21; and one of the blue color resist areas and one of the blue-light quantum dot areas are sequentially stacked and received in one of the deposition troughs 21, so as to ensure the light emission wavelength of the quantum dot layer 40 is identical to the light transmission wavelength of the color resist layer 30.

Further, in the present invention, the quantum dot layer 40 is made up of quantum dots, and the quantum dots have outside surfaces that are combined with surface modification groups. The surface modification groups help reduce surface energy of the quantum dots. In the instant embodiment, the surface modification groups comprise fluorine-contained groups. It is appreciated that the surface modification groups may comprise other groups that help reduce the surface energy of the quantum dots. By combining surface modification groups on a surface of a quantum dot material, surface energy of the quantum dot material can be reduced to allow the quantum dot layer 40 and the color resist layer 30 to be simultaneously formed.

The present invention also provides a manufacturing method of a color filter substrate. Referring to FIG. 2, the manufacturing method of a color filter substrate is provided for manufacturing the above-described color filter substrate 100 and comprises the following steps:

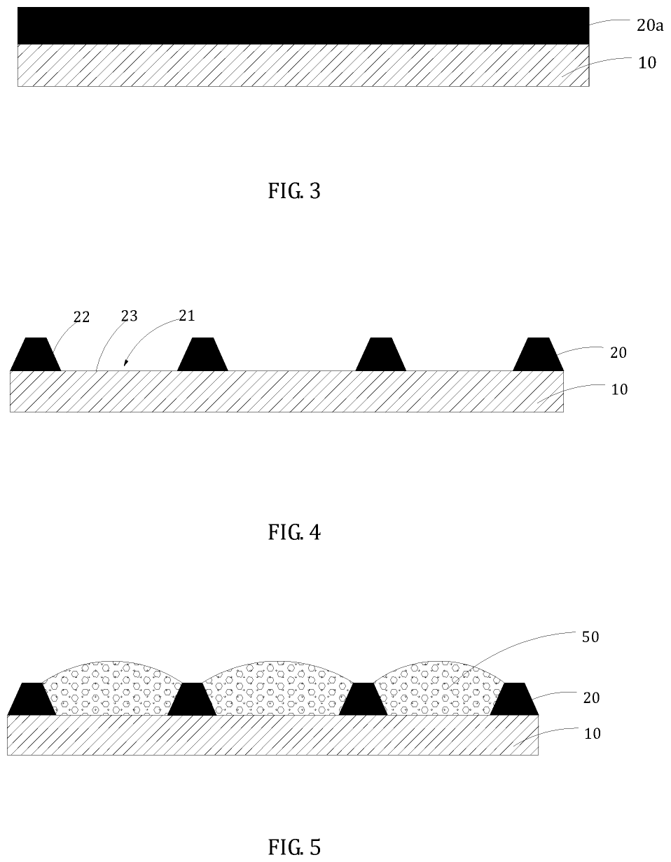

Step 201, referring to FIG. 3, providing a base plate 10 and depositing a black matrix material layer 20a on the base plate 10.

The base plate 10 is a transparent plate, which can be a glass plate that is rigid or a plastic plate that is flexible. In the instant embodiment, the base plate 10 is a transparent glass plate. The black matrix material layer 20a is formed through inkjet printing, printing, or spin coating on any one of surfaces of the base plate 10.

Step 202, referring to FIG. 4, patterning the black matrix material layer 20a to form a black matrix 20.

The black matrix 20 is formed by coating a photo resist layer on the black matrix material layer 20a and subjecting the photo resist layer to development and exposure, followed by subjecting the black matrix material layer 20a to etching. The black matrix 20 comprises a plurality of deposition troughs 21 arranged in an array. The deposition troughs 21 each comprise a sidewall 22 and a bottom wall 23. The bottom wall 23 comprises a surface of the base plate 10 that faces the black matrix 20.

Step 203, synthesizing and forming quantum dots, such that the quantum dots having outside surfaces that are combined with surface modification groups.

A surface modification agent is added in a raw material for making quantum dots so that after formation of quantum dots through synthesis, the outside surfaces of the quantum dots are combined with surface modification groups. Or, alternatively, after formation of quantum dots of which outside surfaces are not combined with surface modification groups through synthesis, the quantum dots that are formed and do not have surface modification groups attached to the outside surfaces thereof are allowed to react with a surface modification agent to form quantum dots including surface modification groups attached to the outside surfaces thereof.

By combining surface modification groups on outside surfaces of quantum dots to modify the surface of the quantum dot material, surface energy of the quantum dot material could be reduced. In the instant embodiment, the surface modification agent is fluorine-contained ligands. Further, quantum dots that emit light of different colors can be provided by adjusting the size of the quantum dots to change an emission light wavelengths of the quantum dots. In the instant embodiment, the quantum dots include green-light quantum dots, red-light quantum dots, and blue-light quantum dots.

Step 204, providing a color resist material and a solvent and mixing the color resist material and the quantum dots so synthesized and formed with the solvent to form color filter mixture solutions 50.

The solvent is used to mix the color resist material and the quantum dots so synthesized and formed to form the color filter mixture materials 50. The solvent comprises one of water, alcohol, and glycerol. In the instant embodiment, the color resist material comprises a blue color resist material, a red color resist material, and a green color resist material. By mixing color resist materials of different colors and quantum dots that emit light of different colors, color filter mixture solutions 50 for different colors can be formed. In the instant embodiment, the red-light quantum dot, the red color resist material. and the solvent are mixed to form a red color mixture solution; the green-light quantum dot, the green color resist material, and the solvent are mixed to form the green color mixture solution; and the blue-light quantum dot, the blue color resist material, and the solvent are mixed to form the blue color mixture solution.

Step 205, referring to FIG. 5, depositing the color filter mixture solutions 50 in the deposition troughs 21, respectively.

The color filter mixture solutions 50 of different colors are respectively deposited in the deposition troughs 21 through inkjet printing, printing, or spin coating.

Step 206, referring back to FIG. 1, drying the color filter mixture solutions 50 to simultaneously formed a color resist layer 30 and a quantum dot layer 40 stacked on the color resist layer 30.

In the present invention, drying the color filter mixture solutions 50 comprises the following steps: first, naturally drying the color filter mixture solutions 50 to have the quantum dots and the color resist materials contained in the color filter mixture solution 50 to naturally separate into different layers; and then applying vacuum drying or heating drying to the color filter mixture solutions to fast remove the solvent contained in the color filter mixture solutions so as to simultaneously form the color resist layer 30 and the quantum dot layer 40 stacked on the color resist layer with the color resist layer 40 being located between the base plate 10 and the quantum dot layer 40. Through drying of the color filter mixture solutions 50, the color resist materials contained in the color filter mixture solutions 50 form the color resist layer 30, and the quantum dot materials contained in the color filter mixture solution 50 form the quantum dot layer 40. Further, in the instant embodiment, the red-light quantum dots form red-light quantum dot layer areas after drying and the red color resist material form red color resist layer areas after drying; the green-light quantum dots form green-light quantum dot layer areas after drying and the green color resist material forms green color resist layer areas are drying; and the blue-light quantum dots form blue-light quantum dot layer areas after drying and the blue color resist material forms blue color resist layer areas after drying.

During the process of drying the color filter mixture solutions 50, due to the relatively low surface energy of the quantum dots, the quantum dots autonomously move toward surfaces of the color filter mixture solutions so that the quantum dots and the color resist materials automatically separate from each other and the color resist material layers are located between the quantum dot material layers and the base plate 10. Thus, through the drying of the color filter mixture solutions 50 so formed, the color resist layer 30 and the quantum dot layer 40 stacked on the color resist layer 30 can be formed simultaneously. In other words, with just one operation, the formation of the color resist layer 30 and the quantum dot layer 40 can be achieved and the operations for manufacturing the color filter substrate 100 can be reduced and the manufacturing cost lowered.

The present invention also provides a display panel. The display panel comprises a liquid crystal layer, an array substrate and the above-described color filter substrate 100. The array substrate and the color filter substrate 100 are arranged opposite to each other. The liquid crystal layer is located between the color filter substrate 100 and the array substrate.

The present invention further provides a display device. The display device comprises a backlight source and the above-described display panel. The backlight source is arranged on one side of the array substrate of the display panel that is distant from the color filter substrate 100. The backlight source gives off light toward the display panel and the light passes through the color resist layer 30 and the quantum dot layer 40 formed in the plurality of deposition troughs 21 to emit combined light of three primary colors (red, blue, and green) to thereby provide a displaying effect of rich colors. Further, since emission of light is achieved by means of quantum dot materials of photoluminescence, color purity of emitting light could be relatively high. Further, adding the color resist layer 30 between the quantum dot layer 40 and the base plate 10 could prevent light leaking of the quantum dot layer 40 to thereby further improve the purity of the emitting light of the display device. The backlight source is a blue-light or violet-light backlight source.

The disclosure made above provides just one preferred embodiment of the present invention and should not be construed as limitations to the scope of the present invention. Skilled artisans of this field would appreciate that modifications, in an equivalent form, of the appended claims that are obtained through realizing and practicing all or some of the process provided in the above embodiment fall within the scope of the present invention.

What is claimed is:

1. A color filter substrate, comprising a base plate and a color resist layer and a quantum dot layer sequentially stacked on the base plate, the quantum dot layer having a light emission wavelength identical to a light transmission wavelength of the color resist layer, quantum dots having outside surfaces that are combined with surface modification groups.

2. The color filter substrate according to claim 1, wherein the color filter substrate further comprises a black matrix, the black matrix being stacked on the base plate, the black matrix comprising a plurality of deposition troughs arranged in an array, the deposition troughs having a bottom wall comprising the base plate, the quantum dot layer comprising a plurality of quantum dot layer areas arranged in an array, the color resist layer comprising a plurality of color resist layer areas arranged in an array, each of the deposition troughs receiving one of the quantum dot layer areas and one the color resist layer areas deposited therein such that the color resist layer area is located between the quantum dot layer area and the base plate.

3. The color filter substrate according to claim 2, wherein the plurality of quantum dot layer areas comprise multiple red-light quantum dot areas and multiple green-light quantum dot areas, or alternatively comprise multiple red-light quantum dot areas, multiple green-light quantum dot areas, and multiple blue-light quantum dot areas; the plurality of color resist layer areas comprise multiple red color resist areas and multiple green color resist areas, or alternatively comprise multiple red color resist areas, multiple green color resist areas, and multiple blue color resist areas, wherein in each of the deposition troughs, the quantum layer area deposited therein has an emission light color that is identical to a color of the color resist layer area deposited therein.

4. The color filter substrate according to claim 1, wherein the surface modification groups comprise fluorine-contained groups.

5. A manufacturing method of a color filter substrate, comprising the following steps:
providing a base plate and depositing a black matrix material layer on the base plate;
patterning the black matrix material layer to form a black matrix, wherein the black matrix comprises a plurality of deposition troughs arranged in an array;
synthesizing and forming quantum dots, such that the quantum dots having outside surfaces that are combined with surface modification groups;
providing a color resist material and a solvent and mixing the color resist material and the quantum dots so synthesized and formed with the solvent to form color filter mixture solutions;
depositing the color filter mixture solutions in the deposition troughs, respectively; and
drying the color filter mixture solutions to simultaneously form a color resist layer and a quantum dot layer stacked on the color resist layer, wherein the color resist layer is located between the base plate and the quantum dot layer.

6. The manufacturing method of a color filter substrate according to claim 5, wherein the step of “drying the color filter mixture solutions” comprises:
allowing the color filter mixture solutions to dry naturally so as to have the quantum dots and the color resist material contained in the color filter mixture solution separate into different layers; and
applying vacuum drying or heating drying to the color filter mixture solutions to remove the solvent from the color filter mixture solution so as to simultaneously formed the color resist layer and the quantum dot layers stacked on the color resist layer with the color resist layer being located between the base plate and the quantum dot layer.

7. The manufacturing method of a color filter substrate according to claim 5, wherein the surface modification groups comprise fluorine-contained groups.

8. The manufacturing method of a color filter substrate according to claim 5, wherein the solvent comprises one of water, alcohol, and glycerol.

9. A display panel, comprising a liquid crystal layer, an array substrate, and a color filter substrate, the array substrate and the color filter substrate being arranged opposite to each other, the liquid crystal layer being located between the color filter substrate and the array substrate, wherein the color filter substrate comprises a base plate and a color resist layer and a quantum dot layer sequentially stacked on the base plate, the quantum dot layer having a light emission wavelength identical to a light transmission wavelength of the color resist layer, quantum dots having outside surfaces that are combined with surface modification groups.

10. The display panel according to claim 9, wherein the color filter substrate further comprises a black matrix, the black matrix being stacked on the base plate, the black matrix comprising a plurality of deposition troughs arranged in an array, the deposition troughs having a bottom wall comprising the base plate, the quantum dot layer comprising a plurality of quantum dot layer areas arranged in an array, the color resist layer comprising a plurality of color resist layer areas arranged in an array, each of the deposition troughs receiving one of the quantum dot layer areas and one the color resist layer areas deposited therein such that the color resist layer area is located between the quantum dot layer area and the base plate.

11. The display panel according to claim 10, wherein the plurality of quantum dot layer areas comprise multiple red-light quantum dot areas and multiple green-light quantum dot areas, or alternatively comprise multiple red-light quantum dot areas, multiple green-light quantum dot areas, and multiple blue-light quantum dot areas; the plurality of color resist layer areas comprise multiple red color resist areas and multiple green color resist areas, or alternatively comprise multiple red color resist areas, multiple green color resist areas, and multiple blue color resist areas, wherein in each of the deposition troughs, the quantum layer area deposited therein has an emission light color that is identical to a color of the color resist layer area deposited therein.

12. The display panel according to claim 9, wherein the surface modification groups comprise fluorine-contained groups.
